(19) United States
(12) Patent Application Publication
(10) Pub. No.: US 2012/0328759 A1
(43) Pub. Date: Dec. 27, 2012

(54) METHOD FOR PRODUCING A CHEESE PRODUCT CONTAINING MILK SOLIDS LOWER THAN OR EQUAL TO 50% AND COMPRISING AT LEAST ONE CEREAL

(75) Inventor: Christophe Cheneval-Pallud, Perrigny (FR)

(73) Assignee: FROMAGERIES BEL, Paris (FR)

(21) Appl. No.: 13/394,599

(22) PCT Filed: Sep. 9, 2010
(86) PCT No.: PCT/FR10/51881

§ 371 Date: Sep. 12, 2012

(30) Foreign Application Priority Data
Sep. 9, 2009 (FR) 09 56137

(51) Int. Cl. A23C 19/082; A23C 19/093; A23C 19/09

(52) U.S. Cl. 426/582; 426/520

(57) ABSTRACT

The invention relates to a method for producing a cheese product containing milk solids ≦50% and consisting of a mixture of melted cheese and of at least one cereal, and to a cheese product which may be produced by the method. The cheese product is characterized by a long shelf life, i.e. a shelf life which may be up to 4 months at room temperature.

The invention relates to a method for producing a cheese product containing a dry weight content ≦50%, consisting of a mixture of melted cheese and of at least one cereal, as well as to a cheese product which may be obtained with this method. The cheese product is characterized by a long shelf life which may attain 4 months at room temperature.

Presently, melted cheeses are found on the market for different uses: to be spreaded, cut, crunched, cooked, dipped, and in different formats (triangular, parallelepipedal, prismatic, cylindrical portions, or slices, trays, pots, cups, etc. . . . ). These products may be plain and/or flavored and may optionally contain inclusions (walnuts, hazelnuts, formed elements, etc. . . . ).

By [symbol] melted cheese [symbol] is traditionally meant products derived from melting, by means of a heat treatment between 80 and 140° C., of cheeses and/or other dairy products (full and/or skimmed milk powder), milk protein concentrates, milk and/or vegetable fats, etc. Because of the selection of the raw materials used in their formulation and in their production technology, this category of cheeses has many advantages notably because of their possibilities of preservation (up to 1 year), of the creation of an infinite palette of tastes and textures, and of the good nutritional value of the products which may be adapted to the needs.

Within the scope of the present invention, the term of <<melted cheese>> will relate to the melted product or base obtained by a heat treatment, at a temperature comprised between 100 and 140° C., of a mixture of at least one protein material of dairy origin and of at least one fat of animal and/or vegetable origin, in the presence of melting salts and/or other emulsifying and/or texturizing agents.

If the melted cheeses have a nutritional value equivalent to that of other cheeses (fresh cheeses, hard cheeses, cooked pressed cheeses, soft cheeses, blue cheeses, kneaded-curd cheeses), they nevertheless have certain drawbacks: their cost, because of the cost of the raw materials entering their composition; and the deficiency in complex carbohydrates or polyosides which are recommended by nutritionists within the scope of a balanced food diet in which they should represent 50 to 55% of the total energy intakes. The main polyoside is starch, a reserve substance of major plants. For example, it represents up to 90% of the dry extract from rice.

The major cereals grown worldwide are wheat, rice, maize, barley, sorghum and millet. They are grown on all continents and represent the food base for humans; they are adapted to the climate under which they are grown: wheat for temperate climates, rice for hot and humid climates, sorghum for dry climates.

They are consumed in the form of cooked seeds (for example, rice, wheat, maize) or used in the form of flour, essentially transformed into different foods: bread from different flours, pasta, etc. . . .

Thus, rice is the 3^{rd} cereal produced worldwide after maize and wheat, and it is the first cereal consumed and the food base for more than half of the world population, for which it provides 50% of the calories. It is grown on five continents but production and trade thereof are 90% concentrated on the Asian continent.

These cereals are rich in polyosides in the form of starch; starch is formed with 2 polymers: amylase and amylopectin. In cultivated and industrially utilized plants, the proportions are from 5 to 50% of amylase and from 50 to 95% of amylopectin. These levels are variable depending on the species and within a same species depending on the varieties.

Cereal products have always had a significant role in feeding children and adults, both by their energy provision and also notably in certain populations for which they are the main food by their provision of proteins (comprised between 7% for rice and 12% for wheat or sorghum). Cereal proteins have an interesting composition of indispensable amino acids, although inferior to that of animal proteins because of their lack of sulfur-containing amino acids including lysine, which contributes to finding on the market a foodstuff having animal protein/plant protein complementarity in order to have a provision of the whole of the amino acids in the required amounts. For this purpose, a cereal/cheese association would be particularly appreciated.

Moreover, cereals contain vitamins from the group B (B1 or thiamine, B2 or riboflavin, B6 or pyridoxine, PP or niacin) but are lacking in vitamins A, C and D. They are also characterized by a high content of potassium (300 mg/100 g), magnesium (100-180 mg/100 g) and phosphorus (300-400 mg/100 g) but a low calcium content (20 to 60 mg/100 g).

Table of the composition of cereals:

| | Humidity | Proteins | | Carbohydrates | Fibers (g) | | | Minerals | | |
|---|---|---|---|---|---|---|---|---|---|---|
| Foodstuff | (%) | (g Nx 6.25) | Lipids (g) | (g) | food | insoluble | lignin | (Ashes) (g) | Energy (kJ) | kcal |
| Brown rice | 14 | 7.3 | 2.2 | 71.1 | 4.0 | (2.7) | (0.1) | 1.4 | 1610 | 384 |
| Wheat | 14 | 10.6 | 1.9 | 61.6 | 10.5 | (7.8) | (0.6) | 1.4 | 1570 | 375 |
| Maize | 14 | 9.8 | 4.9 | 60.9 | 9.0 | (6.8) | (0) | 1.4 | 1660 | 396 |
| Millet | 14 | 11.5 | 4.7 | 64.6 | 37 | (2.3) | (0) | 1.5 | 1650 | 395 |
| Sorghum | 14 | 8.3 | 3.9 | 57.4 | 13.8 | (12.4) | (3.0) | 2.6 | 1610 | 384 |
| Rye | 14 | 8.7 | 1.5 | 60.9 | 13.1 | (8.4) | (1.4) | 1.8 | 1570 | 375 |
| Barley | 14 | 9.3 | 5.9 | 63.0 | 5.5 | (39) | (0) | 2.3 | 1640 | 392 |

If melted cheese is a recent product (20^{th} century), the cheese produced and consumed for ages by pastoral populations before its industrialization forms a basic foodstuff appreciated by its provision of proteins and calcium, and of its ease of use. Moreover its provision of different indispensable amino acids gives it an excellent biological value.

However, because of its lack of polyosides, the consumption of which is recommended by nutritionists, this shows how interesting it is to propose a composite product consisting of a cheese/cereals combination with good preservation even out of the cold chain on all continents and under all climates, easy to consume, practical.

Products are already known which combine cheese, including melted cheese, with cereals (essentially bread), this combination may be accomplished directly or indirectly. These combinations were in majority produced in milk-producing countries where the predominant cereal is wheat, whence in majority, combinations of bread or biscuit/cheeses.

As examples of a direct combination of cheese and of a cereal product such as bread or other products derived from the processing of wheat, mention may be made of:
sandwiches, widely marketed in countries with traditional consumption of bread and cheeses but these products, except for frozen products, have a very short shelf life (<1 week in the cold), they often have to be prepared just before consumption;
cheese biscuits, but the cheese is provided in the form of dry powder.

Within the scope of an extended shelf life in the non-frozen condition, it is very difficult to combine both of these types of product because of the transfer of humidity between the humid product (cheese) and the dry product (bread), in the absence of any intermediate protective layer against this transfer. Indeed, the cereal product loses its taste and texture integrity. The applicant has moreover filed a patent application (FR 2 769 471) on a direct combination of melted cheese and of cereal product, but this combination as a cereal product, required exclusive use of cereal products of the Genoese sponge or sandwich loaf type, since both of these cereal products may be consumed humid without losing their integrity. However, the combination was reduced to a cereal product type and the finished product was expensive because of the cost of the raw materials.

In order to solve this problem of humidity transfer, the manufacturers turn towards the marketing of both of these products, cheese and the cereal product in the form of an indirect combination, i.e. the products are packaged in two separate compartments and only come into contact at the moment they are consumed. If, by this means, humidity transfer is avoided and the integrity of the products is preserved, the drawback lies both in the handling to be carried out by the consumer upon consumption, and in the amounts of packaging to be used, which is detrimental for the environment.

Now, it would be of interest to propose to the consumer an easy-to-use product with good preservation, associating cheese and cereal components so as to provide the consumer with a unique product associating the nutritional values of cereals and cheese. This product would have the advantage of improving cereal consumption in countries where it needs to be improved and of providing dairy proteins of excellent nutritional value to populations who are lacking them.

Moreover, all the contemplated combinations have been made with cereal products already transformed into finished products (bread, biscuits).

The applicant has shown unexpectedly that by wisely selecting cereals having a determined amylose level and by applying a suitable production method, it was possible to obtain a unique composite food product by simply mixing a melted base and a non-transformed cereal in the native condition, either hydrated or not, with an extended shelf life, even out of the cold chain.

The amylose level is important for three reasons: 1) it exerts an action on the texture of the finished product: the lower the amylose level, the smoother is the texture; 2) it influences stability over time: the lower the amylose level, the more the product keeps its firmness (less variability of the penetrometry level); a low amylose level leads to low syneresis due to less downgrading of starch.

The applicant moreover showed that the mixture is recommended since the juxtaposition of a cereal layer and of a cheese layer causes softening of the cereal which may be deleterious as regards taste and texture.

The invention relates to a food product nutritionally balanced with macronutrients consisting of a homogeneous mixture of melted cheese and of at least one cereal in which the cereal portion represents up to 60% of the mixture (expressed as hydrated cooked cereal) or up to 15% of the mixture expressed by dry cereal weight.

Within the scope of the invention, the cereal preferentially has an amylose content of less than 20%, still preferentially less than 10%.

The cheese product according to the invention has a dry weight content 50%, more specially comprised between 30 and 40%, and it provides all the macronutrients required for human nutrition, proteins, lipids and carbohydrates in a ratio close to the nutritional intakes recommended by the WHO (World Health Organization). The nutritional intakes of macronutrients recommended by the WHO are (expressed as a % of the total energy intake):
protein intake: 12%;
lipid intake: 33%;
carbohydrate intake including complex carbohydrates: 55%

The cheese product according to the invention, if it may be considered as a food with good nutritional value, cannot be considered as a whole food since it only forms a portion of the food diet.

It is advantageously presented in a practical package, preferentially in the form of consumption dose units (<50 g).

The shelf life of the product may attain 4 months at room temperature and a fortiori at a temperature of less than 15° C. where it may may attain 8 months.

The invention also relates to a method for producing said product.

International patent applications WO 2007/049981 and WO 2008/054232 have described the production of a cheese product which involves the use of a flour ingredient, in particular based on cereals and tubers, and more particularly on rice, up to a level of 10% in formulations for melted cheeses. The ingredient is incorporated in the form of native starch and/or flour. Application WO 2007/049981 discloses that the rice flour ingredient has an amylopectin level of less than 90%. The goal is to use this starch or this flour in order to partly replace the protein portion of the formulations (casein) in order to obtain sufficiently firm products so as to be sliced, grated, crunched, and easily detachable slices from the package (plastic film). Rice starch and/or flour are used for technological purposes and not with the purpose of providing the consumer with a product of good nutritional quality.

The methods described in these patent applications have several drawbacks:
they only use rice in the form of flour. Now, the applicant by tests in a pilot workshop has shown that the incorporation of rice in the form of flour may give the finished product, depending on the types of flour, a floury texture and flour aftertastes which are estimated to be redhibitory for the organoleptic properties of the finished product, which led the applicant to suppress the use of flour as a raw material in his/her formulations. Further, the flours often have low sanitary quality whether this be from the microbiological point of view or from the presence of residues, which is not without any impact on the quality of the final product, notably on its preservation, all the more so if lower heat treatment temperatures are used; —the maximum heat treatment temperatures are limited to 100° C. for the method disclosed by the application WO 2008/054232 and to 85° C. for the method disclosed by the application WO 2007/049981, which is limiting for the shelf life;
rice flour is more expensive than grain rice.

These applications do not mention the use in the formulation of cooked cereals in hydrated form, mixed with a base of melted cheese.

Moreover, patent application EP 1 135 028 describes the use of hydrated rice in the production of light cheeses, more specifically kneaded-curd cheeses of the mozzarella type as a substitution for the fat. For this purpose, the rice is cooked by a heat treatment in the presence of water and then subject to strong shearing in order to obtain a [symbol] liquid mixture [symbol] to be incorporated to the kneaded-curd cheese. The [symbol] liquefied [symbol] hydrated cooked rice is incorporated into the cheese and the whole is heated to about 85° C. The cheese is then cooled and molded.

Patent application US 2002/017275, of the same inventor specifies that the rice/water ratio from 1 to 2 is selected so as to allow complete absorption of the water by the rice grains and avoid release of water during the shearing treatment, which explains the selection of 2 as the upper limit.

Patent application US 2006/0172054 describes the production of light kneaded-curd cheeses by another method: the idea here is to incorporate rice flour in curd and to treat the mixture according to traditional steps for producing kneaded-curd paste (heat treatment (68-73° C.), drawing). The rice flour is used in an amount from 0.5 to 10%, preferentially from 2 to 6%, as a substitute for fat and with it, it is possible to obtain a homogeneous and firm product.

Applications EP 1 135 028 and US 2006/0172054 therefore describe the use of rice flour or hydrated rice flour as a substitute for fats exclusively in a pasta filata technology with amounts of less than 10%. Moreover, according to application US 2006/0172054, with amounts of more than 6% it is not possible to obtain complete incorporation of the water/rice mixture into the cheese. Moreover, the water/rice mixture is subject to shearing before incorporation in <<liquid>> form into the cheese and, in order to avoid any release of water during the shearing treatment, the rice/water ratio is limited to 1:2.

The present invention is described in more detail below.

The invention relates to a method for producing a cheese product having a dry weight content ≦50%, preferably comprised between 30 and 40%, and comprising a mixture of a melted cheese and of at least one cereal, said method comprising the steps:

a) heat-treating at a temperature comprised between 100 and 145° C., preferably between 100 and 140° C., for 3 s to 6 mins, a mixture comprising, by weight based on the total weight of the mixture:
5 to 40% of protein material of dairy origin;
15 to 30% of fat;
0.1 to 3% of emulsifying and/or texturizing agent;
water; and
5 to 15% of at least one cereal, expressed as a dry weight of cereal, said cereal being incorporated into the mixture in a hydrated cooked form;

b) hot conditioning the heat-treated mixture at a temperature comprised between 70 and 100° C.;

c) cooling down to a temperature comprised between 5 and 15° C.

The invention also relates to a method for producing a cheese product having a dry weight content ≦50% and comprising a mixture of a melted cheese and of at least one cereal, said method comprising the steps:

a) preparing a melted cheese base by heat treatment at a temperature comprised between 85 and 140° C., preferably between 100 and 140° C., for 3 s to 6 mins, of a mixture comprising, by weight based on the total weight of the mixture:
5 to 40% of protein material of dairy origin;
15 to 30% of fat;
0.1 to 3% of emulsifying and/or texturizing agent; and
water;

b) mixing said melted cheese base with at least one hydrated cooked cereal, said at least one hydrated cooked cereal representing up to 60% by weight (expressed by weight of hydrated cereal) based on the total weight of the mixture with the melted cheese base;

c) heat-treating the mixture of step b) at a temperature comprised between 100 and 145° C., preferably between 100 and 140° C., for 3 s to 6 mins;

d) hot conditioning the heat-treated mixture of step c) at a temperature comprised between 70 and 100° C.;

e) cooling down to a temperature comprised between 5 and 15° C.

In order to optimize the nutritional value of the final product, it is possible to add to the mixture, vitamins, minerals, such as for example: calcium, potassium, magnesium, zinc, iron, iodine, etc. in soluble or insoluble forms.

Preferably, in the mixture of step a) allowing preparation of a melted cheese base, water is in a sufficient amount up to 100% (q.s.p. 100%), i.e. for example the mixture does not contain ingredients other than the protein material of dairy origin, than the fat, emulsifier(s) or texturizing agent(s), and optionally cereal flour and vitamins and/or minerals.

In the methods described above, the heat-treatment step at a temperature comprised between 100 and 145° C., preferably between 100 and 140° C., may for example be conducted for 30 s to 6 mins.

The heat-treatment temperature of step a) is preferentially comprised between 85 and 140° C., advantageously between 100 an 140° C., for a duration from 3 s to 6 mins, preferably 30 s to 6 mins.

The hydrated cooked cereal incorporated into the melted cheese base in step b) will have been cooked for a time and at a temperature suitable for the type of applied cereal, typically by cooking in boiling water or in steam at a temperature from 100 to 120° C. for 15 to 60 mins, advantageously 15 to 30 mins, preferentially 100° C. for 20 to 50 mins, advantageously 20 to 25 mins, with a cereal volume/water volume ratio adapted to each cereal. For example, rice may be cooked with a ratio of 1 volume of rice/2 to 4 volumes of water. With this operation, the rice volume is multiplied by 2 to 4, and the dry weight content of the mass at the end of the cooking is comprised between 20 and 30%. The rice/water ratio will be greater than 2 (in particular 1 portion of rice and 2-3 portions of water).

The cereals are used as those found as such commercially: for example the rice is used in the form of milled rice either ovened or not (i.e. after an ovening and husking hydrothermal treatment (removal of the ligneous husk) or of whole grain rice or cargo rice (preservation of the pericarp). The sticky varieties will be preferred, which have a lower amylose level.

The cereal is incorporated into the melted cheese base in a useful proportion in order to obtain the desired nutritional characteristics of the final product, i.e. a composition providing a nutrient intake close to the recommendations of the WHO (i.e. a protein intake of 12%, a lipid intake of 33% and a carbohydrate intake of 55% of the total energy). As an example, a formulation providing 12% proteins, 32-33% lipids and 55% carbohydrates will be formed by a mixture consisting of 60% of cooked rice (dry rice content=15%) and 40% of melted base.

Generally, the proportion of hydrated cooked cereal will not exceed 60% by weight based on the total weight of the mixture with melted cheese base. Preferably, the proportion of hydrated cooked cereal will be comprised between 30 and 50% of the total weight of the mixture with the melted cheese base. The dry extract content of the hydrated cooked cereal is generally comprised between 20 and 35%, more specifically 22-28%.

The cooking of the mixture of melted cheese and of hydrated cereal may be carried out at a temperature of 100° C. for a few minutes, up to 145° C., or further 140° C. for a few seconds, typically between 100-145° C. for 3 s to 6 mins, or further 100-40° C. for 30 s to 6 min and preferentially between 110 and 140° C. for 3 s to 6 mins. The heat-treatment is carried out with stirring (800-300, preferentially 1,500 to 2,000 rpm), in conventional equipment used in melted cheese technology: either batch cooking appliances of the cutter type (for example those marketed by Stephan®) or continuous heat-treatment appliances of the UHT sterilizer type.

The mixture is then cooled down to the packaging temperature comprised between 70 and 100° C., preferentially between 75 and 95° C.

The advantage of this method is that it allows the cereal grains to be found again in the finished product, thereby creating an original texture contrast.

In the methods according to the invention, the hot conditioned product is preferentially cooled down to a temperature from 5 to 15° C.

It may be kept up to 4 months at room temperature or up to 8 months in the cold (4-10° C.).

In the method according to the invention, it is possible to use a mixture of cereals, or a mixture of at least one cereal with other vegetable sources such as legumes cultivated for their grains, fruit, etc., the latter being in an amount of less than 2% by dry weight. The legumes cultivated for their grains according to the FAO classification group dry beans, broad beans, dry peas, chick peas, white beans (mogettes), Angola peas, cultivated lentils, bambora peas, common vetch, and lupins. Within the scope of the present application, soya bean may also be used as another vegetable source.

The cereals will be selected from those available on the markets and widely consumed worldwide such as wheat, barley, maize, rice; the latter will preferentially be selected for its consumption universality, its worldwide availability and the low amylose content of some varieties. It is also possible to use more local cereals such as quinoa (South America), millet or sorghum (Africa). Cereals available on local markets are also used preferentially where the product will be marketed (rice in Asia, quinoa in South America, millet and sorghum in Africa, wheat in Europe, maize in North America, etc. . . . )

Preferentially, the cereals will be selected from those which have an amylose content of less than 20%, more specifically less than 10%.

By acting on the amylose/amylopectin ratio of the cereal(s) used and on the time/temperature/shearing rate parameters of the production method, it will be possible to obtain a whole range of products with variable consistency and texture properties.

The protein material of dairy origin is selected from the group consisting of full milk powder, skimmed milk powder, caseins, caseinates, dairy protein concentrates, serum protein concentrates, fresh or matured cheeses, curds, yoghurts, fermented milks and a mixture of these protein materials of dairy origin. It is comprised between 5 and 40% of the formulation.

The whole of these raw materials is well known to one skilled in the art and is widely available on the global market. Mention may be made of products marketed by Fonterra, Arla Foods. Their production technology is also described in Vignola C.: Science et Technologie du lait Ed. Polytechnique de Montréal 2002.

The fat is of animal origin, of plant origin or is a mixture of fats of animal and plant origins.

As animal fats, mention may be made of milk fat, anhydrous milk fat, butter, cream. As plant fats, mention may be made of soya bean oil, sunflower, palm, palm kernel, copra, peanut, rapeseed oil and of any plant oil used in the making of food products and available on the market. The amount of fat used in the formulation is comprised between 15 and 30%.

The emulsifiers/texturizing agents will preferably be melting salts well known to one skilled in the art, such as sodium, potassium polyphosphates or sodium, potassium citrates; but also other emulsifiers such as Datems (mono-diglyceride diacetyl-tartaric esters, SSL and CSL (sodium or calcium stearoyl lactylates). They are used alone or as a mixture and incorporated into the formulation at a content comprised between 0.1 and 3%, preferentially between 0.5 and 2%.

Hydrocolloids may be used such as carrageenans, guar, carob, xanthan gum, starch or any other texturizing agent well known to one skilled in the art.

It is also possible to add to the formulation, vitamins or trace elements in order to improve the nutritional properties thereof.

In the method according to the invention, the melted cheese base is made by heat treatment of the mixture of protein material of dairy origin, of fat, of emulsifier and/or texturizing agent, water and optionally cereal flour with stirring (up to rates of 1,500 rpm) in conventional equipment used in the melted cheese technology, or appliances of the cutter type, for example those marketed under the brand of Stephan®) or appliances of the dough mixer, mixer, kneader, cooker-mixer, co-kneader, extruder type.

In preferred embodiments of the invention, a melted cheese base is made from protein powder concentrates (7.5%), from 30% of a 50/50 mixture of dairy fats and of plant fats, from 1% of sodium polyphosphates, and from water q.s.p. 100%. The melted cheese base is then mixed with rice in the form of milled and hydrated rice grains according to the proportions of 80% of melted cheese, 20% of milled and hydrated rice, by weight. The obtained product has a dry weight content of 40%, a protein content of 6%, a lipid content of 26% and a polyoside content of 6% (expressed by dry weight).

The invention also relates to a cheese product obtainable by a method according to the invention.

The cheese product according to the invention has a dry weight content ≦50%, preferably comprised between 30 and 40%, and comprises by dry weight at least 85% of melted cheese.

In particular, the cheese product according to the invention may comprise (by weight based on the weight of the cheese product):

5-10% of protein material of dairy origin;

10-30% of fat;

0.1-3% of emulsifying and/or texturizing agent;

5-15% of at least one cereal;

water as a balance to 100%.

The whole benefit of these cheese products is seen because of the countless possibilities provided by the effective combination of dairy and cereal raw materials both from a nutritional point of view and from a taste and texture point of view.

As for the taste, it may be available in a vast palette desirably adapted to the taste of populations for which the food is intended, either by selection of the raw materials, in particular dairy raw materials, or by adding specific flavors with sugar dominance (fruit, sugar, vanilla, etc. . . . ) or salt dominance (cheese flavor) depending on the case. It is also possible to easily add spices, aromas, formed elements (pepper, cumin, grains, broken nuts, almonds, etc. . . . ).

The final products obtained may have very varied textures according to the desired consumption use: to be crunched, to be spread, to be sucked, to be sliced; generally the product will have a firmness comprised between 20 and 150 g as measured by a Stevens's apparatus. For this purpose, for the measurement, a cylindrical probe with a diameter of 6.35 mm, with a speed of 0.2 mm/s and a depth of 7 mm is used. The measurement is carried out on a sample at 20° C. The result is a penetrometry peak (maximum value) which expresses the firmness of the product. For a product to be spread, this value is comprised between 50 g and 80 g, for a product to be crunched it will be greater than 150 g.

The finished product may be packaged in different packages: pot, tray, flexible bag, slices, portions, dose sachet, sausage forms, etc. . . . In a same package, it is possible to dose homogeneous products as regards taste and texture or to dose different product layers of different tastes, texture and color. An alternation of at least one product layer according to the invention and of at least one multi-cheese layer may also be contemplated.

An advantageous packaging will consist in a flexible bag in a sealed material representing a dose of product to be consumed in any occasion. The advantage of presenting it in a single dose lies in the convenience and in the fact that there is no risk of recontamination after opening it since consumption is immediate and complete. The product may have a semi-liquid texture to be sucked up or a firm texture to be crunched.

Moreover, because of the method used (a heat treatment which may reach 145° C.) and of the hot conditioning (70° C. or more), optimum food safety is achieved, and a shelf life which may attain 4 months at room temperature, and a fortiori at a temperature of less than 15° C., because of the absence of any microbiological alteration flora.

Whether this be by the selection of the raw materials and original ingredients, which give the possibility of obtaining an infinite palette of tastes and textures, by the selected making and conditioning method, the novel product according to the invention is anyhow an adapted, adaptable and shapeable product for all consumers and for all cultures. It is adapted to all modes of consumption since it is not positioned in a specific scope being adaptable to any location and to any way of consuming it: at home, at school, in mass catering or in the street.

The invention is also illustrated by the following examples which do not limit the scope thereof.

### EXAMPLES

### Example 1

### Melted Cheese Containing Rice

Products are made according to four formulations shown in Table 1.

TABLE 1
Composition of the formulations A-D.

| Composition | | | | |
|---|---|---|---|---|
| (by weight) | A | B | C | D |
| Vegetable fat | 15.65 | 15.61 | 21.95 | 14.30 |
| Butter | | | | 14.00 |
| Dairy protein | 8.84 | 13.50 | 7.49 | 7.72 |
| concentrate | | | | |
| Dry rice | 10.00 | | 10.00 | 5.00 |
| Rice flour | | 5.00 | | |
| Kitchen salt | 0.50 | 0.50 | 0.50 | 0.50 |
| Melting salts | 1.00 | 1.00 | 1.00 | 1.00 |
| Citric acid | 0.20 | 0.20 | 0.20 | 0.20 |
| Carrageenans | 0.50 | 0.50 | 0.50 | 0.50 |
| Water | 63.31 | 63.68 | 58.36 | 56.78 |
| | (including | | (including | (including |
| | 30% of | | 30% of | 30% of |
| | water for | | water for | water for |
| | cooking the | | cooking the | cooking the |
| | rice | | rice | rice |
| Total | 100 | 100.00 | 100 | 100 |

The products A, C and D are made according to the following method:
preparation of a mixture consisting, in the proportions indicated by the table, of a protein source (dairy protein concentrate), of fat, of melting salts, of citric acid, of carrageenans, of rice cooked beforehand under the following conditions: cooking of 10 g of dry rice (for 100 g of product) in 30 g of water at 100° C. for 50 mins in water in a ratio of 1 volume of rice for 3 volumes of water; and of water (balance to 100%); for A and B the amount of rice is 40% of the mixture, for D it is 20%.
heat treatment of the mixture with stirring (1,000 rpm) at 145° C. for 3 s
cooling the mixture to 90° C. and directly hot conditioning it in a flexible bag containing 30 g of product;
cooling down to 10° C.

The product B is made according to the following method:
mixing the ingredients of formulation B according to the proportions indicated in Table 1 and heat-treating said mixture with stirring (1,000 rpm) at 100° C. for 2 mins; cooking is carried out in a cutter marketed by Stephan;
cooling down to 80° C. and hot conditioning in a tray at this temperature;
cooling down to 10° C.

Table 2 gives the details of the characteristics and fat and protein contents of the products A to D.

TABLE 2
characteristics of the products A to D

| | A | B | C | D |
|---|---|---|---|---|
| Dry material | 35 | 35 | 40 | 40 |
| Fat content in dry material: | 45 | 45 | 55 | 65 |
| Fats | 15.75 | 15.75 | 22 | 26 |
| Proteins | 6.99 | 9.90 | 6.04 | 5.89 |

The products A and D obtained have a firmness measured with the Stevens apparatus of 150 g and a shelf life of 6 months at 12° C. They are intended for consumption of the [symbol] crunching [symbol] type.

The product B is a product of the spread with a Stevens' value of 60 g, and a shelf life of 4 months at 12° C.

The product C is a product to be crunched with a Stevens' value of 200 g and a shelf life of 4 months at a temperature of 25° C. These shelf lives are confirmed by the results of a preservation program, during which the products were tracked at 12° C., 25° C. and 30° C., on the time-dependent change of the following criteria:
Penetrometry
sweating
microbiological criteria
organoleptics: texture (firmness, lining the mouth, gelled and floury) and taste (aroma intensity, taste of rice, stale, presence of off-flavors).

The products A, C and D were compliant for all the criteria after 4 months at 30° C. and 6 months at 12° C., the product B was only compliant after 4 months at 12° C.

1. A method for producing a cheese product having a dry weight content ≦50% and comprising a mixture of a melted cheese and of at least one cereal, said method comprising the steps:
a) heat-treating, at a temperature comprised between 100 and 145° C. for 3 s to 6 mins, a mixture comprising, by weight based on the total weight of the mixture:
5 to 40% of protein material of dairy origin;
15 to 30% of fat;
0.1 to 3% of an emulsifying and/or texturizing agent;
water; and
5 to 15% of at least one cereal, expressed as dry weight of cereal, said cereal being incorporated to the mixture in the hydrated cooked form;
b) hot conditioning the heat-treated mixture at a temperature comprised between 70 and 100° C.;
c) cooling down to a temperature comprised between 5 and 15° C.

2. The method according to claim 1, wherein the heat-treatment step a) is carried out at a temperature comprised between 100 and 140° C. for 30 s to 6 mins.

3. The method according to claim 1, comprising the steps:
a) preparing a melted cheese base by heat-treating, at a temperature comprised between 85 and 140° C. for 3 s to 6 mins, a mixture comprising, by weight based on the total weight of the mixture:
5 to 40% of protein material of dairy origin;
15 to 30% of fat;
0.1 to 3% of an emulsifying and/or texturizing agent; and
water;
b) mixing said melted cheese base with at least one hydrated cooked cereal, said at least one hydrated cooked cereal representing up to 60% by weight based on the total weight of the mixture with the melted cheese base;
c) heat-treating the mixture of step b) at a temperature comprised between 100 and 145° C. for 2 s to 6 mins;
d) hot conditioning the heat-treated mixture of step c) at a temperature comprised between 70 and 100° C.;
e) cooling down to a temperature comprised between 5 and 15° C.

4. The method according to claim 3, wherein the heat treatment steps a) and c) are carried out a temperature comprised between 100 and 140° C. for 30 s to 6 mins.

5. The method according to claim 3, wherein the mixture of step a) further comprises 5 to 10%, by weight based on the total weight of the mixture, of at least one cereal flour.

6. The method according to claim 2, wherein said at least one hydrated cooked cereal has a dry weight content comprised between 20 and 35%.

7. The method according to claim 1, wherein the cheese product having a dry weight content ≦50% comprises a mixture of cereals.

8. The method according to claim 1, wherein said at least one cereal is selected from the group consisting of rice, wheat, barley, maize, millet, sorghum and quinoa.

9. The method according to claim 1, wherein said at least one cereal has an amylose content of less than or equal to 10%.

10. The method according to claim 1, wherein said protein material of dairy origin is selected from the group consisting of full milk powder, skimmed milk powder, caseins, caseinates, dairy protein concentrates, serum protein concentrates, fresh or aged cheeses, curds, yoghurts, fermented milks, and a mixture of these protein materials of dairy origin.

11. The method according to claim 1, wherein said fat is of animal origin, of plant origin or is a mixture of fats of animal and plant origins.

12. A cheese product having a dry weight content ≦50% and comprising:
5-10% of protein material of dairy origin;
10-30% of fats;
0.1-3% of emulsifying and/or texturizing agent;
5-15% of at least one cereal, expressed as dry weight of cereal, said cereal having been incorporated in a hydrated cooked form; and
water as the balance to 100%.

13. A cheese product having a dry weight content ≦50% and comprising at least one cereal, obtainable by a method according to claim 1.

14. The cheese product according to claim 13, comprising:
5-10% of protein material of dairy origin;
10-30% of fat;
0.1-3% of emulsifying and/or texturizing agent;
5-15% of at least one cereal; and
water as the balance to 100%.

15. The method according to claim 4, wherein the mixture of step a) further comprises 5 to 10%, by weight based on the total weight of the mixture, of at least one cereal flour.

16. The method according to claim 3, wherein said at least one hydrated cooked cereal has a dry weight content comprised between 20 and 35%.

17. The method according to claim 4, wherein said at least one hydrated cooked cereal has a dry weight content comprised between 20 and 35%.
